(19) United States
(12) Patent Application Publication
(10) Pub. No.: US 2014/0144631 A1
(43) Pub. Date: May 29, 2014

(54) Methods of Forming Functionalized Proppant Particulates for Use in Subterranean Formation Operations

(71) Applicant: HALLIBURTON ENERGY SERVICES, INC, Houston, TX (US)

(72) Inventors: Jimmie D. Weaver, Duncan, OK (US); Philip D. Nguyen, Houston, TX (US)

(73) Assignee: Halliburton Energy Services, Inc, Houston, TX (US)

(21) Appl. No.: 13/687,522

(22) Filed: Nov. 28, 2012

(51) Int. Cl. C09K 8/80; E21B 43/267

(52) U.S. Cl. CPC C09K 8/805; E21B 43/267
USPC 166/280.2

(57) ABSTRACT

Methods of treating a subterranean formation including providing proppant particulates; providing a treatment fluid comprising a base fluid and a surface modification agent; coating the proppant particulates with a functional agent so as to form functionalized proppant particulates; wherein the functional agent forms a partial molecular layer coating on the proppant particulates; introducing the functionalized proppant particulates into the treatment fluid; and placing the treatment fluid into the subterranean formation.

### BACKGROUND

The present invention relates to methods of forming functionalized proppant particulates for use in subterranean formation operations.

Subterranean wells (e.g., hydrocarbon producing wells, water producing wells, injection wells, etc.) are often stimulated by hydraulic fracturing treatments. In hydraulic fracturing treatments, a fracturing fluid is pumped into a wellbore in a subterranean formation at a rate and pressure sufficient to create or enhance one or more fractures. Then, either as a portion of the fracturing fluid or in a secondary treatment fluid solid particulates, known as “proppant particulates” or “proppant,” are placed within the formed fractures. The proppant particulates serve to prop the fractures open by preventing them from fully closing after the hydraulic pressure is removed. By propping open the fracture, the proppant particulates aid in forming conductive pathways through which produced fluids may flow.

The degree of success of a hydraulic fracturing treatment depends, at least in part, upon fracture porosity and conductivity once the fracturing operation is complete and production is begun. Traditional fracturing treatments place a large volume of proppant particulates into a fracture to form a “proppant pack” therein. The ability of proppant particulates to maintain a fracture open after the hydraulic pressure is removed depends on the ability of the proppant particulates to withstand fracture closure and, therefore, is typically proportional to the volume of proppant particulates placed in the fracture. In order to ensure that an adequate volume of proppant particulates remain in a fracture, traditional fracturing treatments often involve coating the proppant particulates with a surface modification agent (e.g., a resin, a binding agent, and the like). The surface modification agent minimizes particulate migration and serves to enhance grain-to-grain or grain-to-formation contact between proppant particulates and/or the formation. The surface modification agent may stabilize and lock the proppant particulates into place such that they are at least partially immobilized and resistant to flowing out of the fracture with treatment fluids or produced fluids.

Traditional methods of applying a surface modification agent onto proppant particulates generally comprises mixing together a coupling agent and a surface modification agent to enhance bonding to the proppant particulates. Traditional coupling agents have two reactive sites in their structure. One reacts and forms a chemical bond with the surface hydroxyl groups of the proppant particulates and the second is a dangling organofunctional group that may react with a surface modification agent. When coupling agents are used as part of the surface modification agent composition, a significant amount of the coupling agent is wasted as it is consumed by the reactive functionality of the surface modification agent composition. Only the layer of surface modification agent in physical contact with the particulate surface can utilize the coupling agent to enhance bonding. However, the coupling agent must compete with the surface modification agent in forming a film of coating on the surface of the proppant particulates. Because the majority of the coupling agent is not in physical contact with the proppant particulate surface, it does not contribute to enhancing bonding of the surface modification agent to the proppant particulates. Rather, the additional coupling agent may have a negative impact on the surface modification agent's final properties because the coupling agent within the bulk of the surface modification agent may consume the reactive functionality of the surface modification agent composition. Moreover, because the coupling agent must compete with the surface modification agent, suboptimal coating and suboptimal consolidation of the proppant particulates often occurs. To overcome this problem, traditional methods of applying a surface modification agent onto proppant particulates requires use of an excess amount of coupling agent. However, coupling agents are typically very expensive and are thus cost-prohibitive, particularly because of the large volume required to effectively coat proppant particulates. Therefore, a method of effectively creating proppant particulates coated with a surface modification agent that reduces the amount of coupling agent required may be of benefit to one of ordinary skill in the art.

### SUMMARY OF THE INVENTION

The present invention relates to methods of forming functionalized proppant particulates for use in subterranean formation operations.

In some embodiments, the present invention provides a method of treating a subterranean formation: providing proppant particulates; providing a treatment fluid comprising a base fluid and a surface modification agent; coating the proppant particulates with a functional agent so as to form functionalized proppant particulates; wherein the functional agent forms a molecular layer coating on the proppant particulates; introducing the functionalized proppant particulates into the treatment fluid; and placing the treatment fluid into the subterranean formation.

In other embodiments, the present invention provides a method of treating a subterranean formation: providing proppant particulates; providing a treatment fluid comprising a base fluid and a surface modification agent; coating the proppant particulates with a functional agent so as to form functionalized proppant particulates; wherein the functional agent forms a molecular layer coating on the proppant particulates, and wherein the functional agent is selected from the group consisting of an acrylate silane; a methacrylate silane; an aldehyde silane; an amino silane; a cyclic azasilane; an anhydride silane; an azide silane; a carboxylate silane; a phosphate silane; a sulfonate silane; an epoxy silane; an ester silane; a halogen silane; a hydroxyl silane; an isocyanate silane; a phospine silane; a sulfur silane; a vinyl silane; an olefine silane; a fluorinated alkyl-silane; any polymeric silane thereof; and any combination thereof; introducing the functionalized proppant particulates into the treatment fluid; and placing the treatment fluid into the subterranean formation.

In still other embodiments, the present invention provides a method of treating a subterranean formation providing proppant particulates; providing a treatment fluid comprising a base fluid and a surface modification agent; wherein the surface modification agent is selected from the group consisting of a non-aqueous tackifying agent; aqueous tackifying agents; emulsified tackifying agents; silyl-modified polyamide compounds; resins; crosslinkable aqueous polymer compositions; polymerizable organic monomer compositions; consolidating agent emulsions; zeta-potential modifying aggregating compositions; silicon-based resins; binders; any derivatives thereof; and any combinations thereof; coating the proppant particulates with a functional agent so as to form functionalized proppant particulates; wherein the functional agent forms a molecular layer coating on the proppant particulates, and wherein the functional agent is selected from the group consisting of an acrylate silane; a methacrylate silane; an aldehyde silane; an amino silane; a cyclic azasilane; an anhydride silane; an azide silane; a carboxylate silane; a phosphate silane; a sulfonate silane; an epoxy silane; an ester silane; a halogen silane; a hydroxyl silane; an isocyanate silane; a phospine silane; a sulfur silane; a vinyl silane; an olefine silane; a fluorinated alkyl-silane; any polymeric silane thereof; and any combination thereof; introducing the functionalized proppant particulates into the treatment fluid; and placing the treatment fluid into the subterranean formation.

The features and advantages of the present invention will be readily apparent to those skilled in the art upon a reading of the description of the preferred embodiments that follows.

### DETAILED DESCRIPTION

The present invention relates to methods of forming functionalized proppant particulates for use in subterranean formation operations. As used herein, the term “functionalized proppant particulates” refers to a proppant particulate that is ready to accept a surface modification agent because it is coated with a functionalized agent. As used herein, the term “functional agent” refers to a material that is capable of adhering to a proppant particulate and enhancing the coating of a surface modification agent. As used herein, the term “surface modification agent” refers to any compound that is capable of minimizing proppant particulate migration.

The methods of the present invention may be used in any wellbore in a subterranean formation. As used herein, the term “wellbore” refers to main wellbores (both horizontal and vertical) and lateral wellbores. As used herein, the term “lateral wellbore” refers to a wellbore that extends or radiates from a main wellbore in any direction. Lateral wellbores may be drilled to bypass an unusable portion of a main wellbore or to access particular portions of a subterranean formation without drilling a second, main wellbore.

In some embodiments, the present invention provides for a method of treating a subterranean formation with functionalized proppant particulates. The functionalized proppant particulates are prepared by coating the proppant particulates with a functional agent, placing the functionalized proppant particulates into a treatment fluid comprising a base fluid and a surface modification agent, and placing the treatment fluid into a subterranean formation. The functionalized proppant particulates of the present invention are coated with a functional agent to form at least a partial molecular layer. As used herein, the term “molecular layer” refers to the average thickness of a monolayer of molecules at least one molecular layer thick of a surface modification agent having a reactive site bonded to the surface of a proppant particulate. A typical molecular layer may be from about 0.5 nanometers thick to about 800 nanometers thick. As used herein, the term “partial molecular layer” refers to a monolayer of molecules at least one molecular layer thick that does not fully cover or surround the entire outer surface of a proppant particulate. The methods of the present invention are particularly advantageous because, although only a small quantity of functional agent is necessary to create the partial molecular layer on the proppant particulates, the functionalized proppant particulates are capable of accepting surface modification agents in a significantly more uniform and predictable manner than traditional proppant particulates that have been conventionally treated with a surface modification agent and a coupling agent. Additionally, the functional agent may be designed such that the reactive site of the functional agent may either accept the surface modification agent alone or accept the surface modification agent and change the surface properties of the surface modification agent (e.g., creating a hydrophilic or hydrophobic surface).

In some embodiments, the molecular layer of the functional agent formed on the proppant particulates of the present invention may be in the form of a partial or complete monolayer or a multilayer adsorption. In some embodiments, the functional agent formed on the proppant particulates is in the range from about one to about ten molecular layers. In some preferred embodiments, the functional agent formed on the proppant particulates is in the range from about three to about eight molecular layers. The molecular layers may be interconnected through a loose network structure, intermixed, or both. Application of the functional agent onto the proppant particulates in order to create the functionalized proppant particulates of the present invention may be performed by any technique capable of depositing the functional agent onto the proppant particulates. In some embodiments, the functional agent is deposited onto the proppant particulates of the present invention by spraying, atomizing, steady liquid stream, vapor phase deposition, or aerosol application. The functional agent may be deposited on the proppant particulates prior to beginning a subterranean operation or on-the-fly during the subterranean operations.

The proppant particulates for use in the methods of the present invention may be of any size and shape combination known in the art as suitable for use in a subterranean formation operation (e.g., hydraulic fracturing, screenless frac-packing, screenless gravel-packing, etc.). Generally, where the chosen proppant particulates are substantially spherical, suitable proppant particulates have a size in the range of from about 2 to about 400 mesh, U.S. Sieve Series. In some embodiments of the present invention, the proppant particulates have a size in the range of from about 8 to about 120 mesh, U.S. Sieve Series. A major advantage of using this method is there is no need for the proppant particulates to be sieved or screened to a particular or specific particle mesh size or particular particle size distribution, but rather a wide or broad particle size distribution can be used.

In some embodiments of the present invention, it may be desirable to use substantially non-spherical proppant particulates. Suitable substantially non-spherical proppant particulates may be cubic, polygonal, fibrous, or any other non-spherical shape. Such substantially non-spherical proppant particulates may be, for example, cubic-shaped, rectangular-shaped, rod-shaped, ellipse-shaped, cone-shaped, pyramid-shaped, or cylinder-shaped. That is, in embodiments wherein the proppant particulates are substantially non-spherical, the aspect ratio of the material may range such that the material is fibrous to such that it is cubic, octagonal, or any other configuration. Substantially non-spherical proppant particulates are generally sized such that the longest axis is from about 0.02 inches to about 0.3 inches in length. In other embodiments, the longest axis is from about 0.05 inches to about 0.2 inches in length. In one embodiment, the substantially non-spherical proppant particulates are cylindrical having an aspect ratio of about 1.5 to 1 and about 0.08 inches in diameter and about 0.12 inches in length. In another embodiment, the substantially non-spherical proppant particulates are cubic having sides about 0.08 inches in length. The use of substantially non-spherical proppant particulates may be desirable in some embodiments of the present invention because, among other things, they may provide a lower rate of settling when slurred into a fluid to transport them to desired locations within subterranean formations. By so resisting settling, substantially non-spherical proppant particulates may provide improved proppant particulate distribution as compared to more spherical proppant particulates.

Proppant particulates suitable for use in the present invention may comprise any material suitable for use in subterranean operations. Suitable materials for proppant particulates include, but are not limited to, sand; bauxite;

ceramic materials; glass materials; polymer materials (e.g., ethylene-vinyl acetate or composite materials); polytetrafluoroethylene materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; and any combinations thereof. Suitable composite particulates may comprise a binder and a filler material wherein suitable filler materials include silica; alumina; fumed carbon; carbon black; graphite; mica; titanium dioxide; barite; meta-silicate; calcium silicate; kaolin; talc; zirconia; boron; fly ash; hollow glass microspheres; solid glass; and any combinations thereof.

In some embodiments, a portion of the proppant particulates may be formed from degradable particulates. One purpose of including degradable particulates is to enhance the permeability of the propped fracture. As the degradable particulates are removed with time, the porosity of the propped fracture increases. The degradable particulates are preferably substantially uniformly distributed throughout the formed proppant pack. Over time, the degradable particulates will degrade, in situ, causing the degradable particulates to substantially be removed from the proppant pack and to leave behind voids in the proppant pack. These voids enhance the porosity of the proppant pack, which may result, in situ, in enhanced conductivity.

Suitable degradable particulates include oil-degradable polymers. Oil-degradable polymers that may be used in accordance with the present invention may be either natural or synthetic polymers. Some particular examples include, but are not limited to, polyacrylics; polyamides; polyolefins (e.g., polyethylene, polypropylene, polyisobutylene, and polystyrene); and any combinations thereof.

In addition to oil-degradable polymers, other degradable materials that may be used in conjunction with the present invention include, but are not limited to, degradable polymers; dehydrated salts; and any combinations thereof. As for degradable polymers, a polymer is considered to be “degradable” herein if the degradation is due to, in situ, a chemical and/or radical process such as hydrolysis, or oxidation.

Suitable examples of degradable polymers that may be used in accordance with the present invention include polysaccharides (e.g., dextran or cellulose); chitins; chitosans; proteins; aliphatic polyesters; poly(lactides); poly(glycolides); poly(E-caprolactones); poly(hydroxybutyrates); poly(anhydrides); aliphatic or aromatic polycarbonates; poly(orthoesters); poly(amino acids); poly(ethylene oxides); polyphosphazenes; and any combinations thereof.

A dehydrated salt may be used in accordance with the present invention as a degradable particulate. A dehydrated salt is suitable for use in the present invention if it will degrade over time as it hydrates. For example, a particulate solid anhydrous borate material that degrades over time may be suitable. Specific examples of particulate solid anhydrous borate materials that may be used include, but are not limited to, anhydrous sodium tetraborate (also known as anhydrous borax); anhydrous boric acid; and any combinations thereof. These anhydrous borate materials are only slightly soluble in water. However, with time and heat in a subterranean environment, the anhydrous borate materials react with the surrounding aqueous fluid and are hydrated. The resulting hydrated borate materials are highly soluble in water as compared to anhydrous borate materials and as a result degrade in the aqueous fluid.

In choosing the appropriate degradable material, one should consider the degradation products that will result. These degradation products should not adversely affect other operations or components and may even be selected to improve the long-term performance/conductivity of the propped fracture. The choice of degradable material also can depend, at least in part, on the conditions of the well (e.g., well bore temperature or pH).

In some embodiments of the present invention, from about 5% to about 90% of the total proppant particulates of the present invention are degradable particulates. In other embodiments, from about 20% to about 70% of the total proppant particulates of the present invention are degradable particulates.

In still other embodiments, from about 25% to about 50% of the total proppant particulates of the present invention are degradable particulates. One of ordinary skill in the art with the benefit of this disclosure will recognize an optimum concentration of degradable particulates that provides desirable values in terms of enhanced conductivity or permeability without undermining the stability of the high porosity fracture itself.

Suitable base fluids for use in conjunction with the present invention may include, but not be limited to, oil-based fluids; aqueous-based fluids; aqueous-miscible fluids; water-in-oil emulsions; or oil-in-water emulsions. Suitable oil-based fluids may include alkanes; olefins; aromatic organic compounds; cyclic alkanes; paraffins; diesel fluids; mineral oils; desulfurized hydrogenated kerosenes; and any combination thereof. Suitable aqueous-based fluids may include fresh water, saltwater (e.g., water containing one or more salts dissolved therein), brine (e.g., saturated salt water), seawater, and any combination thereof. Suitable aqueous-miscible fluids may include, but not be limited to, alcohols (e.g., methanol, ethanol, n-propanol, isopropanol, n-butanol, sec-butanol, isobutanol, and t-butanol; glycerins); glycols (e.g., polyglycols, propylene glycol, and ethylene glycol); polyglycol amines; polyols; any derivative thereof; any in combination with salts (e.g., sodium chloride, calcium chloride, calcium bromide, zinc bromide, potassium carbonate, sodium formate, potassium formate, cesium formate, sodium acetate, potassium acetate, calcium acetate, ammonium acetate, ammonium chloride, ammonium bromide, sodium nitrate, potassium nitrate, ammonium nitrate, ammonium sulfate, calcium nitrate, sodium carbonate, and potassium carbonate); any in combination with an aqueous-based fluid; and any combination thereof. Suitable water-in-oil emulsions, also known as invert emulsions, may have an oil-to-water ratio from a lower limit of greater than about 50:50, 55:45, 60:40, 65:35, 70:30, 75:25, or 80:20 to an upper limit of less than about 100:0, 95:5, 90:10, 85:15, 80:20, 75:25, 70:30, or 65:35 by volume in the base fluid, where the amount may range from any lower limit to any upper limit and encompass any subset therebetween. Examples of suitable invert emulsions include those disclosed in U.S. Pat. No. 5,905,061 entitled “Invert Emulsion Fluids Suitable for Drilling” filed on May 23, 1997; U.S. Pat. No. 5,977,031 entitled “Ester Based Invert Emulsion Drilling Fluids and Muds Having Negative Alkalinity” filed on Aug. 8, 1998; U.S. Pat. No. 6,828,279 entitled “Biodegradable Surfactant for Invert Emulsion Drilling Fluid” filed on Aug. 10, 2001; U.S. Pat. No. 7,534,745 entitled “Gelled Invert Emulsion Compositions Comprising Polyvalent Metal Salts of an Organophosphonic Acid Ester or an Organophosphinic Acid and Methods of Use and Manufacture” filed on May 5, 2004; U.S. Pat. No. 7,645,723 entitled “Method of Drilling Using Invert Emulsion Drilling Fluids” filed on Aug. 15, 2007; and U.S. Pat. No. 7,696,131 entitled “Diesel Oil-Based Invert Emulsion Drilling Fluids and Methods of Drilling Boreholes” filed on Jul. 5, 2007, each of which are incorporated herein by reference in their entirety. It should be noted that for water-in-oil and oil-in-water emulsions, any mixture of the above may be used including the water being and/or comprising an aqueous-miscible fluid. The base fluids for use in the present invention may additionally be gelled or foamed by any means known in the art.

Suitable surface modification agents for use in the methods of the present invention may be any surface modification agent suitable for use in a subterranean operation. Suitable surface modification agents may include, but are not limited to, non-aqueous tackifying agents; aqueous tackifying agents; emulsified tackifying agents; silyl-modified polyamide compounds; resins; crosslinkable aqueous polymer compositions; polymerizable organic monomer compositions; consolidating agent emulsions; zeta-potential modifying aggregating compositions; silicon-based resins; binders; any derivatives thereof; and any combinations thereof. Nonlimiting examples of suitable non-aqueous tackifying agents may be found in U.S. Pat. Nos. 7,392,847; 7,350,579; 5,853,048; 5,839,510; and 5,833,000, the entire disclosures of which are herein incorporated by reference. Nonlimiting examples of suitable aqueous tackifying agents may be found in U.S. Pat. Nos. 8,076,271; 7,131,491; 5,249,627; and 4,670,501, the entire disclosures of which are herein incorporated by reference. Nonlimiting examples of suitable crosslinkable aqueous polymer compositions may be found in U.S. Patent Application Publication Nos. 2010/0160187 (pending) and U.S. Pat. No. 8,136,595 the entire disclosures of which are herein incorporated by reference. Nonlimiting examples of suitable silyl-modified polyamide compounds may be found in U.S. Pat. No. 6,439,309 entitled the entire disclosure of which is herein incorporated by reference. Nonlimiting examples of suitable resins may be found in U.S. Pat. Nos. 7,673,686; 7,153,575; 6,677,426; 6,582,819; 6,311,773; and 4,585,064 as well as U.S. Patent Application Publication No. and 2008/0006405 (abandoned) and U.S. Pat. No. 8,261,833, the entire disclosures of which are herein incorporated by reference. Nonlimiting examples of suitable polymerizable organic monomer compositions may be found in U.S. Pat. Nos. 7,819,192, the entire disclosure of which is herein incorporated by reference. Nonlimiting examples of suitable consolidating agent emulsions may be found in U.S. Patent Application Publication No. 2007/0289781 (pending) the entire disclosure of which is herein incorporated by reference. Nonlimiting examples of suitable zeta-potential modifying aggregating compositions may be found in U.S. Pat. Nos. 7,956,017 and 7,392,847, the entire disclosures of which are herein incorporated by reference. Nonlimiting examples of suitable silicon-based resins may be found in U.S. Patent Application Publication Nos. 2011/0098394 (pending), 2010/0179281 (pending), and U.S. Pat. Nos. 8,168,739 and 8,261,833, the entire disclosures of which are herein incorporated by reference. Nonlimiting examples of suitable binders may be found in U.S. Pat. Nos. 8,003,579; 7,825,074; and 6,287,639, as well as U.S. Patent Application Publication No. 2011/0039737, the entire disclosures of which are herein incorporated by reference.

Specific examples of suitable surface modifications agents that are capable of minimizing proppant particulate migration for use in the present invention may include, but are not limited to, an epoxy; a furfuryl alcohol; a furan; a phenolic resin; a vinyl; a urethane; a polyurethane; an acrylate; a methacrylate; an unsaturated polyester; a polyethylene; a polypropylene; a polystyrene; a polycarbonate; an acrylic; a polyamide; a polydiene; a polyphenylene sulfide; a halogen-modified homopolymer; a chlorosulfonyl-modified homopolymer; any derivatives thereof; any copolymers thereof; an any combinations thereof. One of ordinary skill in the art, with the benefit of this disclosure, will recognize the type of surface modification agent to use for a particular subterranean operation. The choice of a surface modification agent may depend, at least in part, on the properties of the subterranean formation (e.g., pH, temperature, salinity, and the like) and the type of functional agent used. In some embodiments, the surface modification agent is present in the methods of the present invention in an amount from about 0.01% to about 10% by weight of the treatment fluid. In preferred embodiments, the surface modification agent is present in the methods of the present invention in an amount from about 0.1% to about 5% by weight of the treatment fluid.

In some embodiments of the present invention, the treatment fluid may further comprise a viscosity control solvent. The viscosity control solvent may be included in the treatment fluid in order to achieve a desired viscosity of the treatment fluid, where the surface modification agent causes the treatment fluid to become overly viscous for the purposes of a particular subterranean operation.

Suitable viscosity control solvents may include, but are not limited to butyl lactate; dipropylene glycol methyl ether; dipropylene glycol dimethyl ether; dimethyl formamide; diethyleneglycol methyl ether; ethyleneglycol butyl ether; diethyleneglycol butyl ether; propylene carbonate; methanol; isopropanol; butyl alcohol; d'limonene; fatty acid methyl esters; butylglycidyl ether; 2-butoxy ethanol; an ether of a C2 to C6 dihydric alkanol containing at least one C1 to C6 alkyl group; a mono ether of a dihydric alkanol; a mono ether of a methoxypropanol; a mono ether of a butoxyethanol; a mono ether of a hexoxyethanol; isomers thereof; and any combinations thereof. Selection of an appropriate viscosity control solvent is dependent on the surface modification agent composition chosen and is within the ability of one skilled in the art, with the benefit of this disclosure.

As described above, use of a viscosity control solvent in the treatment fluids of the present invention is optional but may be desirable to reduce the viscosity of the treatment fluids caused by the surface modification agent for ease of handling, mixing, and transferring. However, it may be desirable in some embodiments to not use such a viscosity control solvent for environmental or safety reasons. It is within the ability of one skilled in the art, with the benefit of this disclosure, to determine if and how much viscosity control solvent is needed to achieve a suitable viscosity. In some embodiments, the amount of the viscosity control solvent used in the treatment fluids of the present invention may be in the range of about 1% to about 60% by weight of the treatment fluid. In preferred embodiments, the viscosity control used in the treatment fluids of the present invention may be in the range of about 5% to about 30% by weight of the treatment fluid.

Traditional proppant particulates that have been treated with a surface modification agent and a coupling agent typically require that the coupling agent be present in an amount from about 0.1% to about 5% by weight of the proppant particulates. The functional agent of the present invention may be coated onto the proppant particulates to form a molecular layer in the range having an upper limit from about 0.5%, 0.4%, 0.3%, 0.2%, 0.1%, 0.09%, 0.08% by weight of the proppant particulates to a lower limit from about 0.07%, 0.06%, 0.05%, 0.04%, 0.03%, 0.02%, 0.01%, 0.009%, 0.008%, 0.007%, 0.006%, 0.005%, 0.004%, 0.003%, 0.002%, 0.001%. In preferred embodiments, the functional agent of the present invention may be present in the range of about 0.01% to about 0.1% by weight of the proppant particulates. Thus, as discussed previously, the methods of the present invention do not require a large amount of costly materials to coat the proppant particulates in order to receive a surface modification agent. Suitable functional agents for use in the methods of the present invention may include, but are not limited to: an acrylate silane; a methacrylate silane; an aldehyde silane; an amino silane; a cyclic azasilane; an anhydride silane; an azide silane; a carboxylate silane; a phosphate silane; a sulfonate silane; an epoxy silane; an ester silane; a halogen silane; a hydroxyl silane; an isocyanate silane; a phospine silane; a sulfur silane; a vinyl silane; an olefine silane; a fluorinated alkyl-silane; any polymeric silane thereof; and any combination thereof. One of ordinary skill in the art, with the benefit of this disclosure, will recognize the type and amount of functional agent to include in the methods of the present invention for a particular subterranean operation depending on, for example, the properties of the subterranean formation, the type and size of proppant particulates used, and/or the type of surface modification agent used.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method of treating a subterranean formation:
providing proppant particulates;
providing a treatment fluid comprising a base fluid and a surface modification agent;
coating the proppant particulates with a functional agent so as to form functionalized proppant particulates wherein the functional agent forms a molecular layer coating on the proppant particulates;
introducing the functionalized proppant particulates into the treatment fluid; and,
placing the treatment fluid into the subterranean formation.

2. The method of claim 1, wherein a portion of the proppant particulates comprise degradable particulates.

3. The method of claim 1, wherein the functional agent is present in an amount from about 0.001% to about 0.5% by weight of the proppant particulates.

4. The method of claim 1, wherein the surface modification agent is present in an amount from about 0.01% to about 10% by weight of the treatment fluid.

5. The method of claim 1, wherein the treatment fluid further comprises a viscosity control solvent selected from the group consisting of butyl lactate; dipropylene glycol methyl ether; dipropylene glycol dimethyl ether; dimethyl formamide; diethyleneglycol methyl ether; ethyleneglycol butyl ether; diethyleneglycol butyl ether; propylene carbonate; methanol; isopropanol; butyl alcohol; d'limonene; fatty acid methyl esters; butylglycidyl ether; 2-butoxy ethanol; an ether of a C2 to C6 dihydric alkanol containing at least one C1 to C6 alkyl group; a mono ether of a dihydric alkanol; a mono ether of a methoxypropanol; a mono ether of a butoxyethanol; a mono ether of a hexoxyethanol; isomers thereof; and any combinations thereof.

6. The method of claim 1, wherein the molecular layer coating on the proppant particulates at least partially coats the proppant particulates.

7. The method of claim 1, wherein the molecular layer coating on the proppant particulates is from about 3 to about 8 molecular layers thick.

8. A method of treating a subterranean formation:
providing proppant particulates;
providing a treatment fluid comprising a base fluid and a surface modification agent;
coating the proppant particulates with a functional agent so as to form functionalized proppant particulates;
wherein the functional agent forms a molecular layer coating on the proppant particulates, and
wherein the functional agent is selected from the group consisting of an acrylate silane; a methacrylate silane; an aldehyde silane; an amino silane; a cyclic azasilane; an anhydride silane; an azide silane; a carboxylate silane; a phosphate silane; a sulfonate silane; an epoxy silane; an ester silane; a halogen silane; a hydroxyl silane; an isocyanate silane; a phospine silane; a sulfur silane; a vinyl silane; an olefine silane; a fluorinated alkyl-silane; any polymeric silane thereof; and any combination thereof;
introducing the functionalized proppant particulates into the treatment fluid; and
placing the treatment fluid into the subterranean formation.

9. The method of claim 8, wherein a portion of the proppant particulates comprise degradable particulates.

10. The method of claim 8, wherein the functional agent is present in an amount from about 0.001% to about 0.5% by weight of the proppant particulates.

11. The method of claim 8, wherein the surface modification agent is present in an amount from about 0.01% to about 10% by weight of the treatment fluid.

12. The method of claim 8, wherein the treatment fluid further comprises a viscosity control solvent selected from the group consisting of butyl lactate; dipropylene glycol methyl ether; dipropylene glycol dimethyl ether; dimethyl formamide; diethyleneglycol methyl ether; ethyleneglycol butyl ether; diethyleneglycol butyl ether; propylene carbonate; methanol; isopropanol; butyl alcohol; d'limonene; fatty acid methyl esters; butylglycidyl ether; 2-butoxy ethanol; an ether of a C2 to C6 dihydric alkanol containing at least one C1 to C6 alkyl group; a mono ether of a dihydric alkanol; a mono ether of a methoxypropanol; a mono ether of a butoxyethanol; a mono ether of a hexoxyethanol; isomers thereof; and any combinations thereof.

13. The method of claim 8, wherein the molecular layer coating on the proppant particulates at least partially coats the proppant particulates.

14. The method of claim 8, wherein the molecular layer coating on the proppant particulates is from about 3 to about 8 molecular layers thick.

15. A method of treating a subterranean formation:
providing proppant particulates;
providing a treatment fluid comprising a base fluid and a surface modification agent;
wherein the surface modification agent is selected from the group consisting of a non-aqueous tackifying agent; aqueous tackifying agents; emulsified tackifying agents; silyl-modified polyamide compounds; resins; crosslinkable aqueous polymer compositions; polymerizable organic monomer compositions; consolidating agent emulsions; zeta-potential modifying aggregating compositions; silicon-based resins; binders; any derivatives thereof; and any combinations thereof;
coating the proppant particulates with a functional agent so as to form functionalized proppant particulates;
wherein the functional agent forms a molecular layer coating on the proppant particulates, and
wherein the functional agent is selected from the group consisting of an acrylate silane; a methacrylate silane; an aldehyde silane; an amino silane; a cyclic azasilane; an anhydride silane; an azide silane; a carboxylate silane; a phosphate silane; a sulfonate silane; an epoxy silane; an ester silane; a halogen silane; a hydroxyl silane; an isocyanate silane; a phospine silane; a sulfur silane; a vinyl silane; an olefine silane; a fluorinated alkyl-silane; any polymeric silane thereof; and any combination thereof introducing the functionalized proppant particulates into the treatment fluid; and
placing the treatment fluid into the subterranean formation.

16. The method of claim 15, wherein a portion of the proppant particulates comprise degradable particulates.

17. The method of claim 15, wherein the functional agent is present in an amount from about 0.001% to about 0.5% by weight of the proppant particulates.

18. The method of claim 15, wherein the resin is present in an amount from about 0.01% to about 10% by weight of the treatment fluid.

19. The method of claim 15, wherein the molecular layer coating on the proppant particulates at least partially coats the proppant particulates.

20. The method of claim 15, wherein the molecular layer coating on the proppant particulates is from about 3 to about eight molecular layers thick.
